(19) United States
(12) Patent Application Publication
(10) Pub. No.: US 2004/0121050 A1
(43) Pub. Date: Jun. 24, 2004

(54) Color-changing beverage compositions

(75) Inventors: Tracy Thurman, Torrance, CA (US); Debbie L. Lohmeyer, San Jose, CA (US); Dale F. Olds, Dublin, CA (US)

Correspondence Address: KOLISCH HARTWELL, P.C., 520 S.W. YAMHILL STREET, SUITE 200, PORTLAND, OR, 97204, US

(73) Assignee: Mattel, Inc.

(21) Appl. No.: 10/651,812

(22) Filed: Aug. 28, 2003

Related U.S. Application Data
(60) Provisional application No. 60/407,490, filed on Aug. 30, 2002.

(51) Int. Cl. A23B 4/00

(52) U.S. Cl. 426/120

(57) ABSTRACT

Beverage preparation kits are disclosed, where the kits include beverage compositions having a first component mixture and a second component mixture, and a calorimetric pH indicator. The two component mixtures are formulated such that combination of the two mixtures during preparation of the beverage results in a detectable color change.

This application is based upon and claims benefit under 35 U.S.C. § 119(e) of U.S. provisional patent application Serial No. 60/407,490, filed Aug. 30, 2002.

### BACKGROUND OF THE INVENTION

The invention generally relates to compositions for preparing instant, or ‘just-add-water’ beverages. More particularly, the invention relates to multiple-component beverage mixtures that exhibit a color change when the components are mixed.

Young children enjoy recreational play that simulates the activities of adults. In particular, the simulation of food preparation has traditionally been a popular play-time activity for children. Such play time activities are enhanced when actual consumable foodstuffs are prepared by the child, providing a sense of accomplishment as well as a tasty treat.

The popularity of such food preparation play activity has led to the development of a variety of toys that simulate food preparation and produce edible food products. For example, U.S. Pat. No. 3,808,730 to Cooper et al. for a TOY OVEN, and U.S. Pat. No. 5,314,373 to Caveza et al. for a TOY FOOD PROCESSOR AND SIMULATED OVEN.

The preparation of edible foodstuffs may also include the preparation of edible versions of traditionally inedible objects, such as insects, worms, etc., or the combination of fantasy play with food product preparation, such as by mixing magical potions or make-believe medicines.

The present invention includes an instant beverage composition that permits a child to make a tasty drink that displays a change in color during preparation.

### SUMMARY OF THE INVENTION

The invention includes a beverage preparation kit having a first component mixture that includes a colorimetric pH indicator, and a second component mixture. The first and second component mixtures are formulated so that the color of the pH indicator in a combined solution of the first and second component mixtures is detectably different from the color of the pH indicator in a solution of the first component mixture.

### BRIEF DESCRIPTION OF THE DRAWINGS

FIG. 1 is a schematic representation of a beverage preparation kit according to an embodiment of the present invention.

### DETAILED DESCRIPTION OF THE PREFERRED EMBODIMENTS

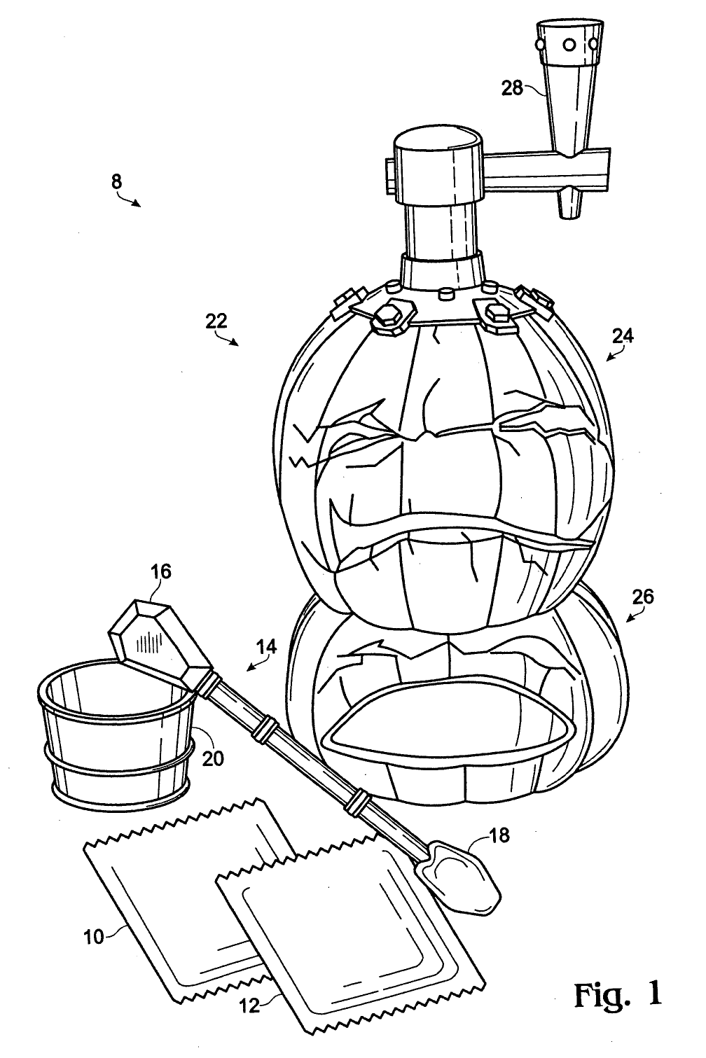

A beverage preparation kit 8 according to the present invention is shown in FIG. 1. The beverage preparation kit includes packet 10 and packet 12, where packet 10 contains a first mixture that includes an edible carbonate salt and an edible colorimetric pH indicator, and packet 12 contains a second mixture that includes an edible acid.

When dissolved in water, the first mixture yields a somewhat basic solution, due to the presence of the carbonate salt. Suitable salts include alkali metal or alkaline earth metal carbonates, or alkali metal or alkaline earth metal bicarbonate salts, among others. For purposes of economy and flavor, sodium bicarbonate is a preferred component of the first mixture.

The second mixture typically includes an edible acid. The edible acid, when combined with a solution of the first mixture, at least partially neutralizes the carbonate salt, thereby lowering the pH and acidifying the solution. Lowering the pH of the solution thereby generates a change in the color of the pH indicator. The edible acid may also be selected based on the flavor characteristics of the acid. Suitable edible acids may include citric acid, malic acid, and/or tartaric acid, among others. A particularly useful edible acid for the purposes of the beverage composition is citric acid.

The edible pH indicator includes any substance that changes color in response to the pH of the solution it is dissolved in. Edible indicators are non-toxic when consumed in amounts that are effective for detecting color changes due to pH variations. The pH indicator may be responsive to narrow or broad pH ranges, and may be show the greatest colorimetric response at alkaline pH ranges, acidic pH ranges, or neutral pH ranges. Particularly useful pH indicators for use in the instant beverage composition include anthocyanins. Anthocyanins are typically present in extracts of red cabbage, such as red cabbage juice, or red cabbage powder. Such extracts of red cabbage are a particularly useful edible pH indicator for inclusion in the first mixture. Red cabbage extracts are typically blue or green at high pH levels (more basic) purple at neutral pH levels, and pink to red at low pH levels (more acidic).

The pH indicator may be packaged separately, but is typically combined with either the first mixture or the second mixture. Where the pH indicator is combined with one of the beverage components, the second component is typically formulated such that combining the two components results in a detectable change in the color of the indicator when in solution. That is, if the first mixture includes a bicarbonate salt and the pH indicator, then the second mixture typically includes sufficient edible acid to produce a pH change to results in a detectable change in the perceived color of the pH indicator, relative to the color of the pH indicator in a solution of the first mixture alone.

The first mixture, the second mixture, or both mixtures optionally include any of a variety of additional flavoring, coloring, sweetening agents, and/or other additives.

Appropriate flavoring agents may include any of the many non-toxic natural or artificial flavoring agents known in the art. In particular, the flavoring agents used may include one or more of a variety of natural or artificial fruit flavors, including orange, lemon, lime, cherry, apply, berry, pineapple, banana, grape, strawberry, watermelon, and kiwi flavorings, among others. Alternatively, or in addition, the flavoring agents may include one or more of natural or artificial cola, root beer, cream soda, vanilla, chocolate, pistachio, pumpkin pie, candy corn, honey, marshmallow, butterscotch, and caramel flavorings, among others. In one aspect, the beverage composition may include one or more of pumpkin pie, honey, and candy corn type flavoring agents.

Sweetening agents may include any of the non-toxic natural or synthetic sweeteners known in the art. Selected natural sweeteners include sucrose, fructose, dextrose, maltose, and maltodextrins, among others. Alternatively, the sweetener may be an amino acid sweetener, such as L-alanine or glycine, an alcohol such as sorbitol, mannitol, or xylitol, or a vegetable extract such as may be obtained from glycyrrhiza glabra (sweet licorice), among others. So-called ‘sugar free’ beverage compositions may be formulated with synthetic sweeteners, such as saccharin, cyclamate salts, sucralose, and selected dipeptide sweeteners, such as L-aspartyl-L-phenylalanine methyl ester (ASPARTAME), among others. Typically, the sweetening agent includes sugar and/or maltodextrin.

Coloring agents may include any of a variety of natural or artificial food colorings that are non-toxic and known in the art, including Red no. 2 (amaranth), Red no. 3 (erythrosine), Red no. 4 (Ponceau SX), DC Red no. 22 (eosine), Red no. 28 (phloxine), Red no. 40 (Allura Red; or disodium salt of 6-hydroxy-5[(2-methoxy-5-methyl-4-sulfophenyl) azo]-2-naphthalenesulfonic acid), Yellow no. 5 (tartrazine; trisodium 5-hydroxy-1-(4-sulfonatophenyl) (4-sulfonatophenylazo)-H-pyrazole-3-carboxylate), DC Yellow no. 1 (quinoline yellow SS), Yellow no. 6 (Sunset Yellow FCF; or disodium salt of 6-hydroxy-5-[(4-sulfophenyl)azo]-2-naphthalenesulfonic acid)), DC Yellow no. 10 (Quinoline Yellow WS), Green no. 3 (Fast Green FCF), DC Green no. 5 (Alizarine Cyanine Green F), DC Green no. 6 (Quinizarine Green SS), Blue no. 1 (Brilliant Blue FCF), Blue no. 2 (Indigo Carmine), annatto, anthocyanins, beet extracts, beta-carotene, caramel, carmine/cochineal, paprika oleoresin, and turmeric, among others. In one embodiment of the invention, the coloring agents include one or more of anthocyanins, and Yellow no. 5.

It should be apparent that a single component of the beverage composition may function as both a coloring agent and a flavoring agent, for example caramel, or as both a pH indicator and a coloring agent, for example anthocyanin. The color of a solution of the pH indicator may be enhanced or modified by the selective addition of additional coloring agents that compliment the color of the pH indicator, either at a higher or lower pH value, or both.

The beverage composition of the invention may be used to prepare a color-changing beverage, according to the following method. The first mixture, including for example both a carbonate salt and a pH indicator, is dissolved in water or a water containing beverage. The pH of the resulting solution will typically be somewhat basic, due to the presence of carbonate salts in the mixture, and the color of the solution will reflect the color of the pH indicator at that pH value, plus the color contributions of any additional coloring agents in the first mixture.

The solution prepared from the first mixture may then be combined with the second mixture, which may be present as a dry composition, or as a solution. The amount of edible acid in the second mixture is typically selected to be sufficient to lower the pH of the resulting combined solution sufficiently that the color of the pH indicator in the combined solution is detectably different than the color of the pH indicator in the first solution alone. That is, the color of the first solution detectably changes upon combination of the first solution with the second mixture. Preferably, the amount of edible acid is sufficient to produce a substantial or even dramatic color change in the pH indicator used in the composition.

As described above, the pH indicator may be in the first mixture or the second mixture. It may be particularly visually satisfying if the mixture containing the pH indicator is dissolved prior to addition of the other mixture, so that the color of the indicator before and after combination is most obvious. However, each mixture may be dissolved before combination, or one mixture may be dissolved, and the resulting solution added to the dry remaining mixture. In a particular aspect, the first mixture includes a pH indicator, and the first mixture is dissolved in water and then added to the second mixture.

The first and second mixtures may be present as a fine or granular composition, that is substantially dry and free-flowing. Alternatively, one or both of the first and second mixtures may be pressed into a tablet or pellet that is dissolved upon addition to water. For example, a tablet including the first mixture may be dissolved in water to yield a first colored solution, with the subsequent addition of a second table that includes the second mixture to the colored solution, thereby producing a color change.

Typically, the first and second mixtures will be packaged in separate pouches or envelopes, or separate segments of a single container, so that they are protected from moisture. Alternatively, or in addition, one or both mixtures may include a non-toxic desiccant, such as silicon dioxide, or other anti-caking agent. Additional additives, such as stabilizing agents, thickening agents, vitamins, minerals, antioxidants, and emulsifiers, in any combination, may also be present in the first mixture, the second mixture, or both.

The beverage composition may include additional component mixtures, that may include additional flavorings, carbonate salts, or edible acids. For example, the color of the beverage may be repeatedly changed by the addition of first a carbonate-containing mixture, then an acid-containing mixture, than an additional carbonate-containing mixture, and so on. In each case, the amount of carbonate or acid in the mixture is selected so as to produce a sufficient pH change to generate a detectable color change of the pH indicator. These additional component mixtures may also be formulated to include additional flavoring agents, additional sweetening agents, and other components as disclosed herein.

The beverage composition may be combined with one or more additional ingredients to prepare the desired beverage. Ice may be added to one or the other mixture, either as ice cubes, crushed ice, or shaved ice, in order to yield a cool drink and/or add texture to the resulting beverage. Similarly, solid or semi-solid additives such as candies, gelatin particles, tapioca beads, and marshmallows, among others, may be included in the beverage composition, or may be added to the beverage in order to accent the appearance, the flavor, and/or the texture of the resulting beverage.

In a particular embodiment of the invention, the beverage composition includes gasified candy particles. Gasified candy typically refers to hard candy that contains a gas, such as carbon dioxide, entrained at high pressure within the candy. Gasified candy is typically prepared by melting crystalline sugar, contacting the sugar with the desired gas at high pressure for a time sufficient to incorporate the gas into the molten sugar, and cooling the sugar under high pressure to produce an amorphous solid. Upon the release of the applied pressure, the solid candy typically fractures into granules. When the granules are wetted, such as by addition to a solution, the trapped gas escapes, with a concomitant fizzing, popping, and sizzling. The gasified candy may be sprinkled into or onto the prepared beverage, or one or more solutions may be poured over the gasified candy. In either case, the dissolution of the gasified candy generates an entertaining effervescence, adding to the enjoyment of the beverage. The gasified candy may be provided in an additional packet or pouch, or it may be included as a component of either the first, second, or additional mixture. In one embodiment, the gasified candy is included in the second mixture.

The beverage composition may be a component of a beverage preparation kit, as shown in FIG. 1. As discussed above, the beverage preparation kit may include the first mixture in packet 10, and the second mixture in packet 12. In addition, the beverage preparation kit may include a spoon utensil 14, that may include both a measuring spoon 16 and a stirring/eating spoon 18. The beverage preparation kit may include a cup 20 or other container for dissolving the first or second mixture in water.

The beverage preparation kit of FIG. 1 may also include an ice shaving apparatus 22, having an upper ice shaving chamber 24 and a lower beverage chamber 26. In one aspect of the beverage preparation kit, the contents of packet 10 (the first mixture) are placed in cup 20 and dissolved in water using spoon utensil 14 to produce a first solution having a first color. Ice may then be added to the upper ice shaving chamber of the ice shaving apparatus and handle 28 turned, generating ice shavings that fall into beverage chamber 26, where they are retained. After a desired amount of ice shavings are generated, the upper chamber 24 may be removed, and the contents of packet 12 (the second mixture) may be sprinkled onto the ice shavings. The first solution may then be poured over the combination of shaved ice and the second mixture, thereby producing a change in the color of the first solution as the pH of the combined mixture is decreased. The resulting slushy, tasty beverage may then be consumed using spoon utensil 14.

The ice shaving apparatus may be decorated, for example as shown in FIG. 1, to complement the beverage composition flavor and/or color, to reflect a particular theme, or to facilitate recreational role-playing and/or fantasy play. In a particular aspect of the ice shaving apparatus, the upper ice shaving chamber and the beverage chamber of the ice shaving apparatus have the appearance of pumpkins or jack 'o lanterns. Alternatively, or in addition, the colors and/or flavors of the first solution and final beverage are selected to yield a beverage having a taste and/or appearance consistent with “pumpkin juice”, candy corn, or a similar autumn-themed foodstuff.

For example, the following beverage compositions may be particularly suited for use with the pumpkin-themed beverage preparation kit depicted in FIG. 1:

### Example 1

First Component Mixture

| | | Grams per |
|---|---|---|
| Ingredients | % by Weight | packet |
| Sugar | 76.460 | 7.65 |
| Maltodextrin | 19.750 | 1.98 |
| Calcium Chloride | 1.500 | 0.15 |
| Cellulose Gum | 1.400 | 0.14 |
| Silicon Dioxide | 0.250 | 0.025 |
| Sodium Bicarbonate | 0.200 | 0.02 |
| Red Cabbage Powder | 0.140 | 0.01 |
| Natural Honey Flavor | 0.100 | 0.010 |
| Natural Pumpkin Pie Flavoring | 0.100 | 0.010 |
| Natural and Artificial Candy Corn Flavoring | 0.100 | 0.010 |

Second Component Mixture

| | | Grams per |
|---|---|---|
| Ingredient | % by Weight | packet |
| Sugar | 74.000 | 7.40 |
| Gasified Candy Granules | 20.000 | 2.00 |
| Citric Acid | 3.000 | 0.30 |
| Maltodextrin | 1.980 | 0.20 |
| Silicon Dioxide | 1.000 | 0.10 |
| Yellow no. 5 | 0.020 | 0.00 |

The above beverage composition may be prepared as follows. The first mixture may be dissolved in 20 mL water to yield a deep purple first solution. The second mixture may then be sprinkled onto shaved ice, and the deep purple first solution may then be poured over the ice/second mixture combination. The first solution changes color from deep purple to orange as it dissolves the second mixture, and the gasified candy begins to effervesce, producing sizzling and popping noises. The resulting icy and/or slushy beverage may be immediately enjoyed.

### Example 2

Alternatively, the beverage composition may include three component mixtures, as set out below:

| | | Grams per |
|---|---|---|
| Ingredient | % by Weight | packet |
| Sugar | 76.460 | 7.65 |
| Calcium Chloride | 1.500 | 0.15 |
| Sodium Bicarbonate | 0.200 | 0.02 |
| Cellulose Gum | 1.400 | 0.14 |
| Red Cabbage Powder | 0.140 | 0.01 |
| Maltodextrin | 19.750 | 1.98 |
| Nat. Honey Flavor | 0.100 | 0.010 |
| Silcon Dioxide | 0.250 | 0.025 |
| Nat. Fl. Powder (Pumpkin Pie Type) | 0.100 | 0.010 |
| N&A Fl. Candy Corn Type | 0.100 | 0.010 |

First Component Mixture

| | | Grams per |
|---|---|---|
| Ingredient | % by Weight | packet |
| Sugar | 81.901 | 4.0950 |
| Sodium Alginate | 2.270 | 0.1135 |
| N&A Orange Cream Flavor | 0.910 | 0.0455 |
| Nat. Flavor Powder | 0.200 | 0.0100 |
| FD&C Yellow #6 | 0.040 | 0.0020 |
| FD&C Red #40 | 0.009 | 0.0005 |
| Citric Acid | 0.456 | 0.0228 |
| Maltodextrin | 14.214 | 0.7107 |

Second Component Mixture

| | | Grams per |
|---|---|---|
| Ingredient | % by Weight | packet |
| Sugar | 74.000 | 7.40 |
| Citric Acid | 3.000 | 0.30 |
| Gasified Candy Granules | 20.000 | 2.00 |
| FD&C Yellow #5 | 0.020 | 0.00 |
| Silicon Dioxide | 1.000 | 0.10 |
| Maltodextrin | 1.980 | 0.20 |

Third Component Mixture

The above beverage composition may be prepared as follows. The first mixture may be dissolved in 20 mL water to yield a deep purple first solution. The second mixture may be dissolved in 10 mL water and added to the first mixture. As the second solution is added, it forms flavored particles that provide additional texture to the combined solution. The third mixture may be sprinkled onto shaved ice, as described in Example 1, and the deep purple solution, including texture particles, may be poured over the ice and third mixture combination. The solution changes color from deep purple to orange as a result, and the gasified candy begins to effervesce as described above.

The disclosure set forth above may encompass multiple distinct inventions with independent utility. Although each of these inventions has been disclosed in its preferred form(s), the specific embodiments thereof as disclosed and illustrated herein are not to be considered in a limiting sense, because numerous variations are possible. The subject matter of the inventions includes all novel and nonobvious combinations and subcombinations of the various elements, features, functions, and/or properties disclosed herein.

Although the present invention has been shown and described with reference to the foregoing operational principles and preferred embodiments, it will be apparent to those skilled in the art that various changes in form and detail may be made without departing from the spirit and scope of the invention. The present invention is intended to embrace all such alternatives, modifications and variances.

What is claimed is:

1. A beverage preparation kit comprising:
a first component mixture that includes a colorimetric pH indicator; and
a second component mixture;
wherein the first and second component mixtures are formulated such that the color of the pH indicator in a combined solution of the first and second component mixtures is detectably different from the color of the pH indicator in a solution of the first component mixture.

2. The beverage preparation kit of claim 1, wherein one of the first and second component mixtures includes an edible carbonate salt, and the other of the first and second component mixtures includes an edible acid.

3. The beverage preparation kit of claim 1, wherein the first component mixture includes sodium bicarbonate, and the second component mixture includes citric acid.

4. The beverage preparation kit of claim 1, where the colorimetric pH indicator includes an anthocyanin.

5. The beverage preparation kit of claim 1, where the colorimetric pH indicator includes a red cabbage extract.

6. The beverage preparation kit of claim 1, where the edible acid is selected from the group consisting of citric acid, malic acid, and tartaric acid.

7. The beverage preparation kit of claim 1, wherein one of the first and second component mixtures includes gasified candy particles.

8. The beverage preparation kit of claim 1, further comprising one or more additional component mixtures that include either an edible acid or an edible carbonate salt.

9. The beverage preparation kit of claim 1, further comprising a mixing cup.

10. The beverage preparation kit of claim 1, further comprising a measuring spoon.

11. The beverage preparation kit of claim 1, further comprising an ice shaving apparatus.

12. A beverage preparation kit comprising:
a first component mixture that includes sodium bicarbonate and red cabbage extract; and
a second component mixture that includes citric acid;
wherein the amounts of sodium bicarbonate in the first component mixture and citric acid in the second component mixture are selected so that the combination of the second component mixture with a solution of the first component mixture results in a detectable color change of the red cabbage extract.

13. The beverage composition of claim 12, where the second component mixture further includes gasified candy particles.

14. A beverage preparation kit, comprising
an ice shaving apparatus;
a first beverage component mixture that includes an edible carbonate salt; and
a second beverage component mixture that includes an edible acid;
wherein at least one of the first and second beverage component mixtures includes a colorimetric pH indicator, and wherein the first and second component mixtures are formulated such that a solution of the first and second component mixtures has a color that is detectably distinct from a color of a solution prepared from only the component mixture that includes the colorimetric pH indicator.

15. The beverage preparation kit of claim 14, wherein the ice shaving apparatus includes an upper ice shaving chamber and a lower beverage chamber.

16. The beverage preparation kit of claim 15, wherein the ice shaving apparatus is configured so that the addition of ice to the upper chamber and subsequent operation of the apparatus generates ice shavings in the lower beverage chamber.

17. The beverage preparation kit of claim 14, further comprising a mixing cup.

18. The beverage preparation kit of claim 14, further comprising a measuring spoon.

19. A method of preparing a beverage, comprising the steps of
preparing a solution of a first component mixture that includes a colorimetric pH indicator and an edible carbonate salt;
adding the solution to a second component mixture that includes an edible acid and gasified candy particles, where the amount of edible acid is sufficient to produce a detectable change in the color of the pH indicator.

20. The method of claim 19, further comprising adding the second component mixture to ice particles before adding the solution of the first component mixture.
